(19) United States
(12) Patent Application Publication
(10) Pub. No.: US 2026/0274406 A1
(43) Pub. Date: Sep. 17, 2026

(54) PIVOTING AIRCRAFT ROTOR ASSEMBLIES

(71) Applicant: Textron Systems Corporation, Hunt Valley, MD (US)

(72) Inventor: Thomas James DeSalvo, Finksburg, MD (US)

(21) Appl. No.: 19/027,474

(22) Filed: Jan. 17, 2025

Related U.S. Application Data
(60) Provisional application No. 63/622,861, filed on Jan. 19, 2024.

(51) Int. Cl. B64C 29/00; B64C 27/50; B64C 27/82

(52) U.S. Cl. CPC B64C 29/0033; B64C 27/50; B64C 27/82; B64C 2027/8218; B64C 2027/8227

(57) ABSTRACT

A technique is directed to controlling a VTOL aircraft. The technique includes operating a first plurality of rotors of a first rotor assembly pivotably attached to a first lateral portion of the VTOL aircraft by a first joint. The first plurality of rotors is constructed and arranged to tilt in unison as the first rotor assembly pivots about the first joint relative to the first lateral portion. The technique further includes operating a second plurality of rotors of a second rotor assembly pivotably attached to a second lateral portion of the VTOL aircraft by a second joint. The second plurality of rotors is constructed and arranged to tilt in unison as the second rotor assembly pivots about the second joint relative to the second lateral portion. The technique further includes adjusting rotational speed of the first plurality of rotors and the second plurality of rotors to control the VTOL aircraft.

### CROSS-REFERENCE TO RELATED APPLICATIONS

This application claims the benefit of U.S. Provisional Patent Application No. 63/622,861, filed Jan. 19, 2024, the contents and teachings of which are incorporated herein by reference in their entirety.

### BACKGROUND

Vertical take-off and landing (VTOL) vehicles employ rotors or thrusters to provide vertical thrust during take-off and landing. Such vehicles may also employ one or more propellers or other thrusters and/or wings for supporting forward flight.

### SUMMARY

Unfortunately, rotors of many conventional VTOL vehicles have fixed positions relative to their airframe, limiting positional control and maneuverability. Consider a situation in which a conventional VTOL vehicle with wings lands while experiencing a horizonal crosswind. In such circumstances, maintaining a stable position over a landing zone involves tilting the entire vehicle to orient the rotors toward the crosswind while still providing vertical thrust (e.g., with one wing rotating diagonally downwards and another wing rotating diagonally upwards). However, tiling the vehicle in this manner increases an amount of surface area exposed to the crosswind, increasing wind resistance and requiring additional thrust to counteract it. Further, before touching down to the ground, the vehicle must reorient itself parallel to the landing zone. As a result, the vehicle tends to drift away from the landing zone shortly before landing, detrimentally impacting positional accuracy. What is needed is a technique that provides enhanced positional control and maneuverability of a VTOL vehicle during takeoff and landing.

The above need is addressed at least in part by an improved technique that provides first and second rotor assemblies pivotably attached to respective first and second lateral portions of a VTOL aircraft by respective first and second joints. Multiple first rotors of the first rotor assembly are constructed and arranged to tilt in unison when the first rotor assembly pivots about the first joint relative to the first lateral portion, and multiple second rotors of the second rotor assembly are constructed and arranged to tilt in unison when the second rotor assembly pivots about the second joint relative to the second lateral portion.

Advantageously, the improved technique provides enhanced maneuverability and control of the VTOL aircraft, especially in high wind conditions. For example, when landing the VTOL aircraft while experiencing a crosswind, the rotor assemblies can pivot without the need for tilting the entire VTOL aircraft. As a result, the rotor assemblies minimize crosswind forces against the VTOL aircraft while still providing counteracting thrust, improving positional accuracy.

Some embodiments are directed to a method of controlling a VTOL aircraft. The method includes operating a first plurality of rotors of a first rotor assembly pivotably attached to a first lateral portion of the VTOL aircraft by a first joint. The first plurality of rotors is constructed and arranged to tilt in unison as the first rotor assembly pivots about the first joint relative to the first lateral portion. The first lateral portion is disposed on a first side of a central axis of the VTOL aircraft. The method further includes operating a second plurality of rotors of a second rotor assembly pivotably attached to a second lateral portion of the VTOL aircraft by a second joint. The second plurality of rotors is constructed and arranged to tilt in unison as the second rotor assembly pivots about the second joint relative to the second lateral portion. The second lateral portion is disposed on a second side of the central axis opposite the first side. The method still further includes adjusting rotational speed of the first plurality of rotors and the second plurality of rotors to control the VTOL aircraft.

Other embodiments are directed to a VTOL aircraft that includes a first rotor assembly and a second rotor assembly, such as the first rotor assembly and the second rotor assembly as described above. Still other embodiments are directed to a VTOL system for an aircraft. The VTOL system includes a first rotor assembly and a second rotor assembly, such as the first rotor assembly and the second rotor assembly described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a top view of an example vertical take-off and landing (VTOL) aircraft in which embodiments of the improved technique can be practiced.

FIG. 2(a) through FIG. 2(c) are respective top, side, and front views of a rotor assembly of FIG. 1 in a deployed condition.

FIG. 3(a) through FIG. 3(c) are respective top, side, and front views of a rotor assembly of FIG. 1 in a stowed condition.

FIG. 4 is a rear view of the VTOL aircraft of FIG. 1, in which the rotor assemblies pivot in roll relative to respective wing portions of the VTOL aircraft.

FIG. 5 is a flowchart of the example operation of FIG. 4.

FIG. 6 is a side view of the VTOL aircraft of FIG. 1, in which the rotor assemblies pivot in pitch relative to respective wing portions of the VTOL aircraft.

FIG. 7 is a flowchart of the example operation of FIG. 6.

FIG. 8 is a top view of the VTOL aircraft of FIG. 1, in which the rotor assemblies rotate the VTOL aircraft in yaw.

FIG. 9 is a flowchart of the example operation of FIG. 8.

FIG. 10 is a flowchart of example activities that may be performed to control the VTOL aircraft of FIG. 1.

FIG. 11 is a flowchart of example activities that may be performed to control the VTOL aircraft of FIG. 1.

FIG. 12 is a block diagram illustrating an example control system of the VTOL aircraft and the rotor assemblies of FIG. 1.

### DETAILED DESCRIPTION

Embodiments of the improved technique will now be described. One should appreciate that such embodiments are provided by way of example to illustrate certain features and principles but are not intended to be limiting.

An improved technique provides first and second rotor assemblies pivotably attached to respective first and second lateral portions of a VTOL aircraft by respective first and second joints. Multiple first rotors of the first rotor assembly are constructed and arranged to tilt in unison when the first rotor assembly pivots about the first joint relative to the first lateral portion, and multiple second rotors of the second rotor assembly are constructed and arranged to tilt in unison when the second rotor assembly pivots about the second joint relative to the second lateral portion.

In some embodiments, the first and second lateral portions are respective wings of the VTOL aircraft.

In some embodiments, each of the rotor assemblies is a respective quadcopter.

In some embodiments, the rotors in each of the rotor assemblies are coupled together and when operating have a fixed orientation relative to other rotors in the respective rotor assembly.

In some embodiments, each of the rotor assemblies is constructed and arranged to adjust individual rotational speeds of the rotors in the respective rotor assembly to pivot the respective rotor assembly relative to the respective wing portion without the use of an actuator.

In some embodiments, each of the rotor assemblies is constructed and arranged to adjust rotational speeds of the rotors in the respective rotor assembly individually.

In some embodiments, each of the rotor assemblies includes two forward rotors and two aft rotors. In these embodiments, each of the rotor assemblies is constructed and arranged to establish a difference in rotational speed between respective forward rotors and respective aft rotors to provide pitch pivoting about the joint of the respective rotor assembly relative to the respective wing portion.

In some embodiments, each of the rotor assemblies includes two outer rotors and two inner rotors. In these embodiments, each of the rotor assemblies is constructed and arranged to establish a difference in rotational speeds between respective outer rotors and respective inner rotors to provide roll pivoting about the joint of the respective rotor assembly relative to the respective wing portion.

In some embodiments, the first rotor assembly and the second rotor assembly are constructed and arranged to rotate the VTOL aircraft about a yaw axis of the VTOL aircraft. In these embodiments, the first rotor assembly is constructed and arranged to run the aft rotors faster than the forward rotors to create a forward-facing pitch of the first rotor assembly relative to the first wing portion of the VTOL aircraft. Further, the second rotor assembly is constructed and arranged to run the aft rotors slower than the forward rotors to create a rearward-facing pitch of the second rotor assembly relative to the second wing portion of the VTOL aircraft. The differential pitch of the first and second rotor assemblies creates yaw motion of the VTOL aircraft.

In some embodiments, each of the first joint and the second joint is constructed and arranged to allow the respective rotor assembly to pivot in pitch and in roll relative to the respective wing portion of the VTOL aircraft.

In some embodiments, each of the first joint and the second joint is constructed and arranged to prevent pivoting in yaw.

In some embodiments, each of the rotor assemblies includes a respective central member and respective rotor arms. Each central member is constructed and arranged to pivot about the respective joint relative to the respective wing portion. The rotor arms have respective first ends pivotably attached to the respective central member. The rotor arms further have second ends coupled with the rotors of a respective rotor assembly.

In some embodiments, each of the central members includes (1) a first end coupled with respective forward rotor arms of the respective rotor assembly and (2) a second end coupled with respective aft rotor arms of the respective rotor assembly.

In some embodiments, each of the first rotor assembly and the second rotor assembly is constructed and arranged to assume (1) a deployed condition in which the respective rotors extend outwardly from the respective central member via the rotor arms and (2) a stowed condition in which the respective rotors are inwardly rotated towards the respective central member via the rotor arms.

In some embodiments, the first rotor assembly includes a first pylon, and the second rotor assembly includes a second pylon. Each of the pylons provides an enclosure that contains at least part of the rotors of the respective rotor assembly in the stowed position.

In some embodiments, each of the first joint and the second joint is constructed and arranged to prevent the respective rotor assembly from pivoting while the respective rotor assembly is in the stowed condition. Additionally or alternatively, in some embodiments, each of the rotor assemblies is constructed and arranged to prevent the respective rotor assembly from pivoting while the respective rotor assembly is in the stowed condition. For example, in some embodiments, one or more interfacing portions of respective rotors and/or rotor arms are constructed and arranged to contact one or more support points on the respective wing portion to prevent rotation about the respective joint while the respective rotor assembly is in the stowed condition.

In some embodiments, each of the first joint and second joint is constructed and arranged to prevent the respective rotor assembly from pivoting in response to detecting a rotor failure in the respective rotor assembly.

In some embodiments, each of the pylons includes respective pylon doors constructed and arranged to cover the respective rotors of the respective rotor assembly while the respective rotor assembly is in the stowed condition.

In some embodiments, each of the pylons defines a respective set of slots. In these embodiments, the respective rotors are constructed and arranged to extend through the respective set of slots.

In some embodiments, the first rotor assembly is coupled with a first underside of the first wing portion. Further, the second rotor assembly is coupled with a second underside of the second wing portion. Further, each of the first rotor assembly and the second rotor assembly includes a respective set of landing features that support the VTOL aircraft while the VTOL aircraft is on the ground.

In some embodiments, a first control system is constructed and arranged to control operation of the first rotor assembly. Additionally, a second control system is constructed and arranged to control operation of the second rotor assembly. Further, a central control system of the VTOL aircraft is constructed and arranged to control both the first control system and the second control system. Alternatively, in some embodiments, a single control system is constructed and arranged to directly control operation of the first rotor assembly, the second rotor assembly, and the VTOL aircraft.

In some embodiments, the VTOL aircraft further includes a propeller that provides thrust along the longitudinal axis of the VTOL aircraft. In some embodiments, the central control system of the VTOL aircraft is further constructed and arranged to control operation of the propeller to move the VTOL aircraft horizontally.

In some embodiments, the VTOL aircraft wing includes non-fixed-wing portions alternatively or in addition to the fixed-wing portions. In some embodiments, the non-fixed-wing portions are constructed and arranged to assume different configurations, e.g. based on flight-state condition, etc.

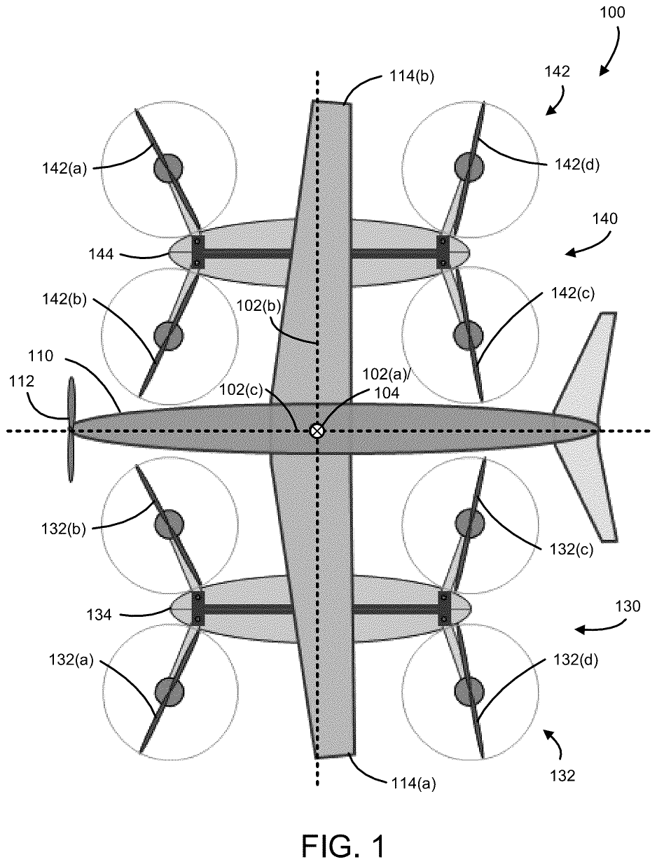

FIG. 1 shows an example VTOL aircraft 100 according to one or more embodiments. The VTOL aircraft 100 includes a fuselage 110, a propeller 112, a first wing portion 114 (a), a second wing portion 114 (b), a first rotor assembly 130, and a second rotor assembly 140. The forward propeller 112 is constructed and arranged to provide thrust for horizontal flight. The first wing portion 114 (a) and the second wing portion 114 (b) are coupled with the fuselage 110. In an example, the first wing portion 114 (a) and the second wing portion 114 (b) are fixed wings. It should be understood that FIG. 1 is provided for example purposes, and in some embodiments, the wing portions 114 are part of a single wing or respective wings of the VTOL aircraft 100.

The VTOL aircraft 100 defines a coordinate system with a yaw axis 102(a), a pitch axis 102(b), and a roll axis 102(c). As shown, the yaw axis 102(a), the pitch axis 102(b), and the roll axis 102(c) intersect at a center of gravity 104 of the VTOL aircraft 100. In some embodiments, the roll axis 102(c) is colinear or otherwise coincident with a central axis of the VTOL aircraft. The first wing portion 114 (a) and the second wing portion 114 (b) are laterally disposed on opposite sides of this central axis.

The first rotor assembly 130 includes first rotors 132(a) through 132(d) (collectively, a first plurality of rotors 132) and a pylon 134. The pylon 134 is pivotably attached to the first wing portion 114 (a). The rotors of the first plurality of rotors 132 are coupled to the pylon 134 and are arranged to tilt in unison as the pylon 134 pivots relative to the first wing portion 114 (a). Similarly, the second rotor assembly 140 includes second rotors 142(a) through 142(d) (collectively, a second plurality of rotors 142) and a pylon 144. The rotors of the second plurality of rotors 142 are coupled to the pylon 144 and are arranged to tilt in unison as the pylon 144 pivots relative to the second wing portion 114 (b).

According to one or more embodiments, the first plurality of rotors 132 and the second plurality of rotors 142 are provided as respective quadcopters. As shown, each of the first plurality of rotors 132 and the second plurality of rotors 142 includes respective forward rotors and respective aft rotors. The forward rotors are positioned forward of the aft rotors relative to the VTOL aircraft 100. As shown, the rotors 132(a), 132(b), 142(a), and 142(b) are forward rotors; and the rotors 132(c), 132(d), 142(c), and 142(d) are aft rotors. Further, each of the first plurality of rotors 132 and the second plurality of rotors 142 includes respective inner rotors and respective outer rotors. The inner rotors are positioned closer to the central roll axis 102(c) than the outer rotors. As shown, the rotors 132(b), 132(c), 142(b), and 142(c) are inner rotors; and the rotors 132(a), 132(d), 142(a), and 142(d) are outer rotors.

During operation, each of the rotor assemblies 130, 140 is able to adjust the rotational speed of its individual rotors to pivot the respective rotor assembly relative to the respective wing portion. In this manner, the rotor assemblies 130, 140 positionally direct thrust relative to the VTOL aircraft 100 without needing to tilt the entire VTOL aircraft 100 (e.g., the fuselage, wing portions, and landing gear). These features are particularly beneficial in gust conditions that exert high and/or inconsistent wind forces on the VTOL aircraft 100.

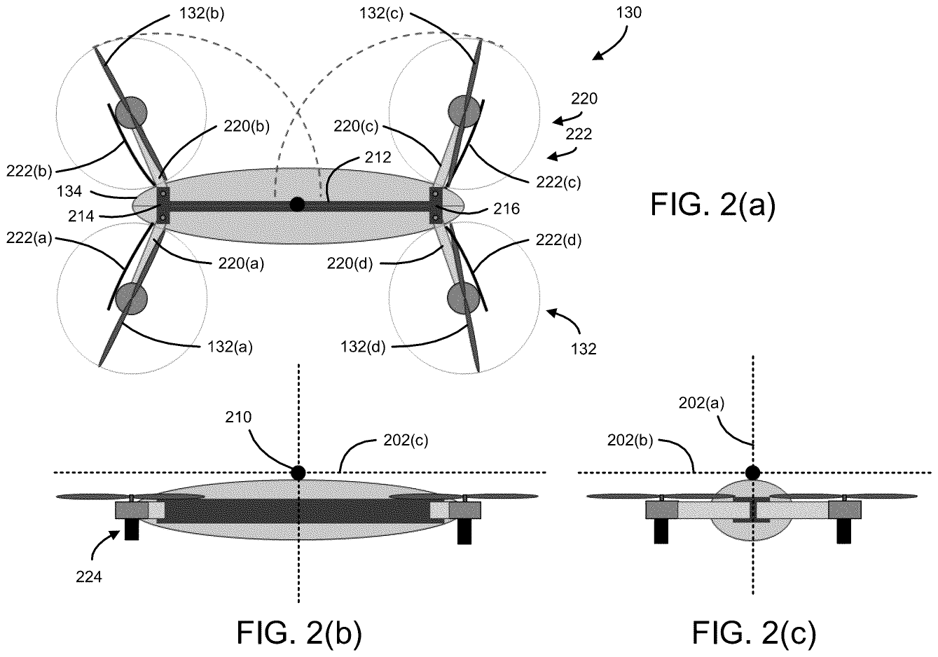

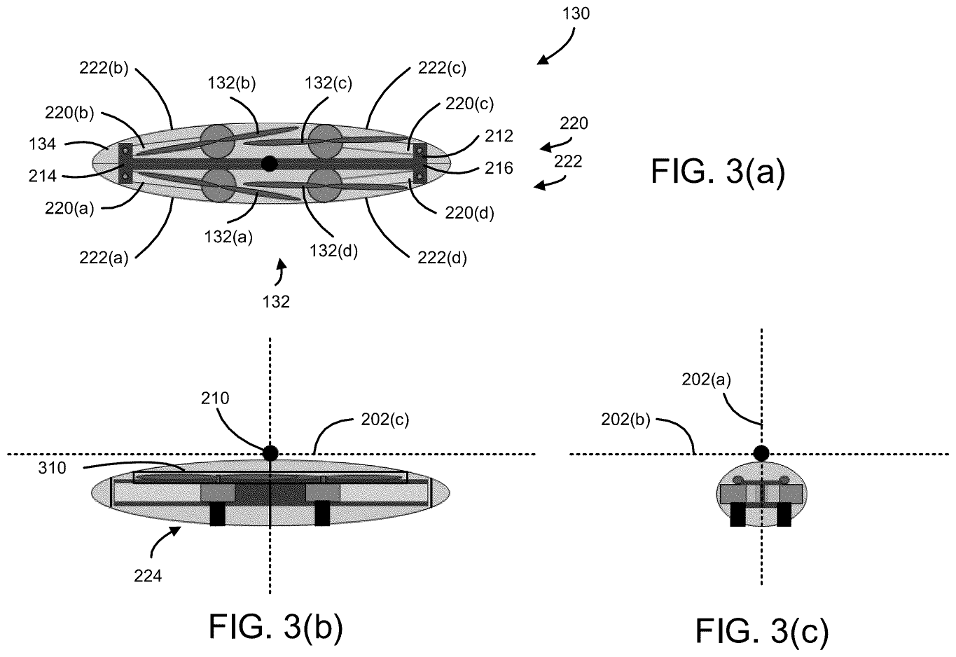

FIG. 2(a) through FIG. 2(c) and FIG. 3(a) through FIG. 3(c) show additional features of the first rotor assembly 130. It should be understood that, in some embodiments, the second rotor assembly 140 includes similar features as those shown for the first rotor assembly 130. Likewise, in some embodiments, the second rotor assembly 140 functions similarly to the first rotor assembly 130, as described in further detail below.

As shown in FIG. 2(b), the first rotor assembly 130 includes a pivotable joint 210. The joint 210 is constructed and arranged to selectively allow the first rotor assembly 130 to rotate relative to the first wing portion 114 (a). Example joints include universal joints, ball joints, combinations thereof, etc.

As shown in FIGS. 2(b) and 2(c), the pivotable joint 210 defines a local coordinate system including a local yaw (normal) axis 202(a), a local pitch (transverse) axis 202(b), and a local roll (longitudinal) axis 202(c) of the first rotor assembly 130. In some embodiments, the local yaw axis 202(a), the local pitch axis 202(b), and the local roll axis 202(c) are parallel to the aircraft yaw axis 102(a), the aircraft pitch axis 102(b), and the aircraft roll axis 102(c), respectively.

In some embodiments, the joint 210 is constructed and arranged to selectively enable the first rotor assembly 130 to pivot about the local pitch axis 202(b) and the local roll axis 202(c) relative to the first wing portion 114 (a). In some embodiments, the joint 210 includes a guide member (not shown) that prevents the first rotor assembly 130 from pivoting about the local yaw axis 202(a), e.g., to enhance positional control over the VTOL aircraft 100, to prevent the first rotor assembly 130 from contacting a fuselage 110 of the VTOL aircraft 100, combinations thereof, etc. As will be described further below, pivoting the first rotor assembly 130 about the local yaw axis 202(a) is not required for turning the VTOL aircraft 100 in yaw.

In some embodiments, the joint 210 is constructed and arranged to assume a locked configuration and an unlocked configuration. In the locked configuration, the joint 210 prevents the first rotor assembly 130 from pivoting relative to the first wing portion 114 (a), e.g., to minimize drag on the VTOL aircraft 100, to increase stability, combinations thereof, etc. In the unlocked configuration, the joint 210 allows the first rotor assembly 130 to pivot relative to the first wing portion 114 (a), e.g., to provide enhanced positional control when landing, hovering, etc.

In some embodiments, the joint 210 is constructed and arranged to selectively allow the first rotor assembly 130 to pivot a maximum of ±20 to ±30° about the pitch axis 202(b) and ±20 to ±30° about the roll axis 202(c), relative to the first wing portion 114 (a).

As shown best in FIG. 2(a), the first rotor assembly 130 includes rotor arms 220 (a) through 220 (d) (collectively, rotor arms 220) coupled with a central member 212. In some embodiments, the rotor arms 220 are constructed and arranged to swing relative to the central member 212 to deploy the rotors 132 and to stow the rotors 132 within the first pylon 134. In some embodiments, the rotor arms 220 are constructed and arranged to extend and/or retract using one or more springs, motors, actuators, combinations thereof, etc.

In some embodiments, the rotor arms 220 are biased towards an outwardly extended (deployed) condition (e.g., the configuration as shown in FIG. 2(a) through FIG. 2(c)) by one or more tensioners (e.g., a linear spring, torsion spring, combinations thereof, etc.). In some embodiments, the rotor arms 220 are constructed and arranged to receive a rotational force to assume an inwardly oriented (stowed) condition (e.g., the configuration as shown in FIG. 3(a) through FIG. 3(b)).

As shown best in FIG. 2(a), the forward rotor arms 220 (a) and 220 (b) are coupled with the forward end 214 of the central member 212 and the aft rotor arms 220 (c) and 220 (d) are coupled with the aft end 216 of the central member 212. The couplings may include hinges that allow the rotor arms 220 to swing between the stowed and extended conditions.

As shown best in FIG. 2(a), the first rotor assembly 130 includes the pylon 134 with pylon doors 222(a) through 222(d) (collectively, pylon doors 222). In some embodiments, the pylon 134 provides an aerodynamically streamlined enclosure that stores the rotors 132 when the first rotor assembly 130 assumes the stowed condition. These features are particularly beneficial in long-range/long-endurance VTOL aircraft.

In some embodiments, the pylon doors 222 rotate to open and close when deploying and stowing the rotors 132, for example, by a set of tensioners. As shown in FIG. 3(b), the pylon 134 defines a slot 310 through which the rotors 132 are configured to extend. In some embodiments, the rotors 132 extend through the slot 310 when assuming the deployed condition. In some embodiments, the pylon 134 defines more or fewer slots, e.g., one slot per side (inner and outer), one slot per rotor, a singular slot for all rotors, no slots, etc.

As shown best in FIG. 2(b), the first rotor assembly includes landing features 224. In some embodiments, the landing features 224 are disposed at least partially within the first pylon 134 (FIG. 3(b)), with portions extending out of the first pylon 134 (FIG. 3(c)). In some embodiments, the landing features 224 include wheels, legs, pads, or other attachments. It should be understood that landing features 224 are provided for example purposes, and in some embodiments, landing features are coupled with the first rotors 132, the first pylon 134, the rotor arms 220, combinations thereof, etc.

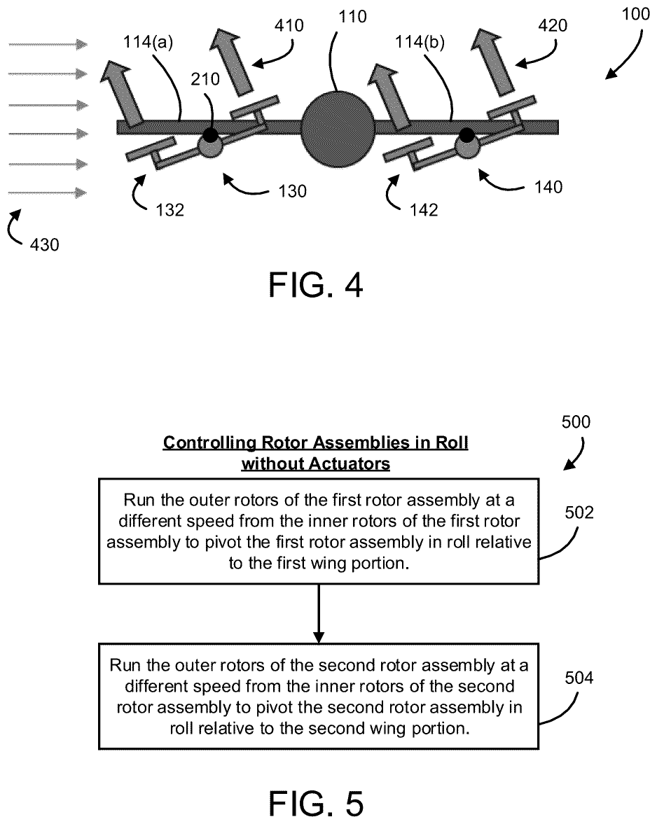

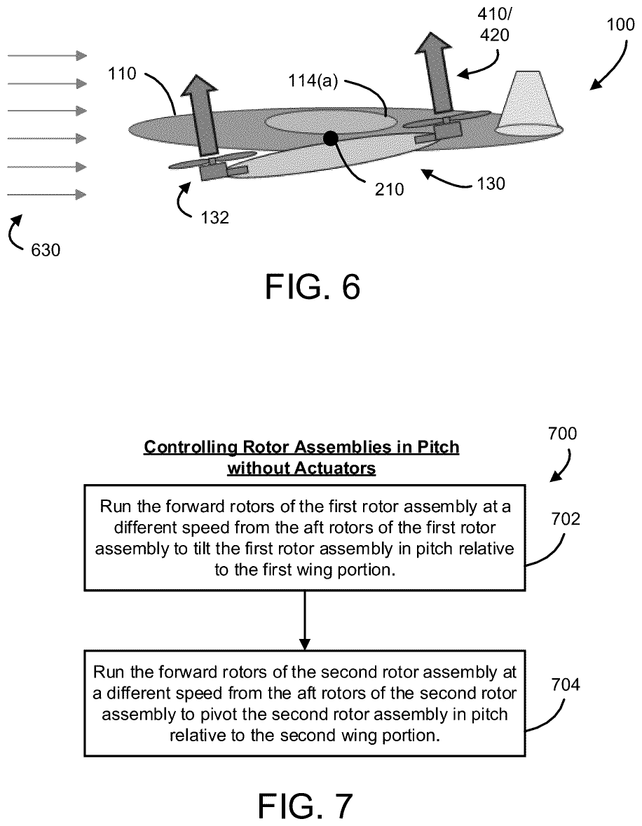

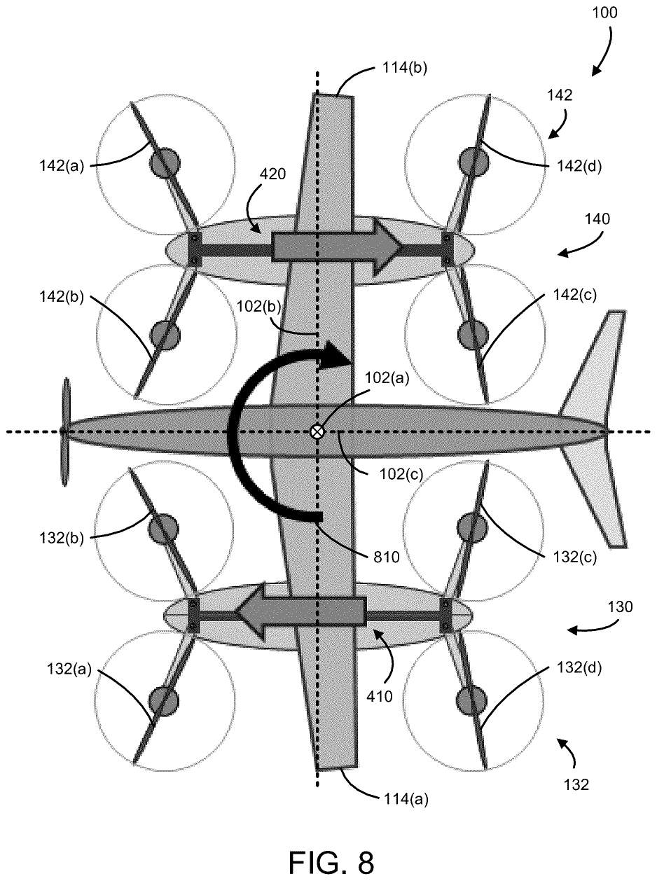

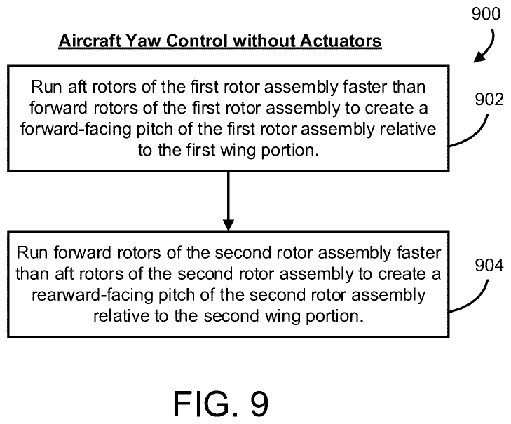

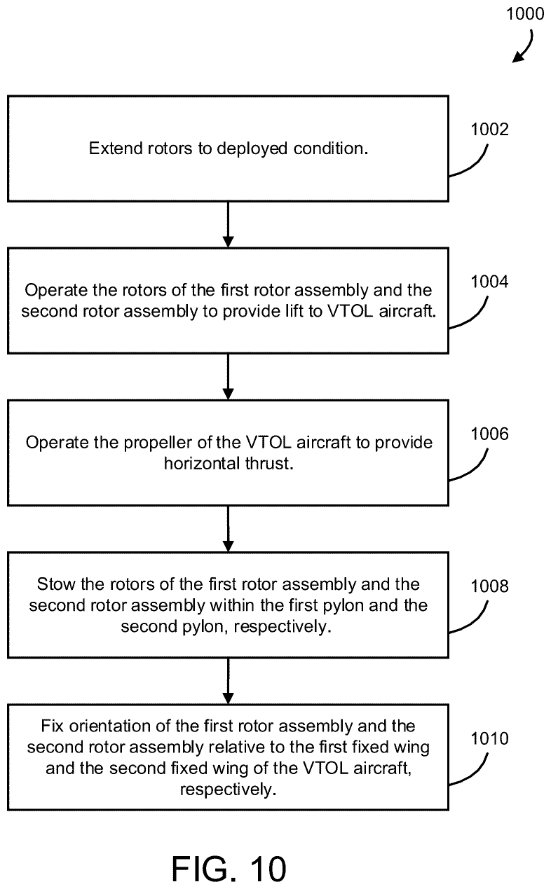

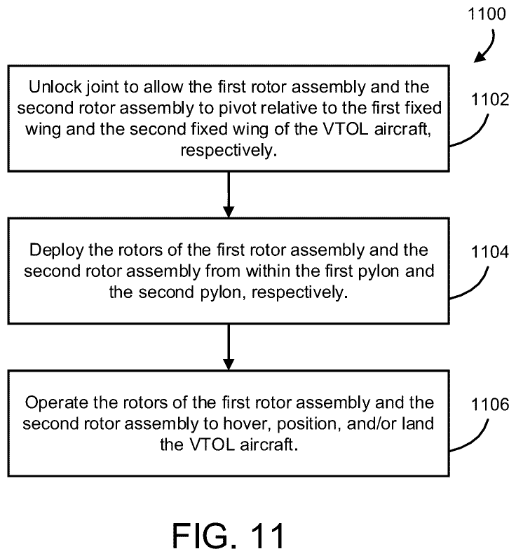

FIGS. 4-11 show example operations that may be carried out using the first rotor assembly 130 and the second rotor assembly 140. FIGS. 4 and 5 show example operations for providing leftward and/or rightward thrust relative to the VTOL aircraft 100. FIGS. 6 and 7 show example operations for providing forward and/or aftward thrust relative to the aircraft 100. FIGS. 8 and 9 show example operations for rotating the VTOL aircraft 100 about the aircraft yaw axis 102(a). FIG. 10 shows an example operation for vertical take-off of the VTOL aircraft 100 based on lift provided by the rotor assemblies 130, 140. FIG. 11 shows an example operation for vertically landing the VTOL aircraft 100 under control of the rotor assemblies 130, 140.

FIG. 4 shows an example rear view of the VTOL aircraft 100. As shown, the rotor assemblies 130, 140 provide respective forces 410, 420 in the left-right direction relative to the VTOL aircraft 100. Further shown are crosswind forces 430 which act against the VTOL aircraft 100.

During operation, the first rotor assembly 130 spins its inner rotors 132(b) and 132(c) (closer to the fuselage 110) faster than it spins its outer rotors 132(a) and 132(d). In contrast, the second rotor assembly 140 spins its inner rotors 132(b) and 132(c) (closer to the fuselage 110) slower than it spins its outer rotors 132(a) and 132(d). In this manner, the first rotor assembly 130 and the second rotor assembly 140 provide complementary horizontal thrust to counteract the crosswind forces 430.

In some arrangements, pivoting of the rotor assemblies 130, 140 is provided without the use of positional actuators. Instead, the rotor assemblies 130, 140 are free to rotate about their respective joints based on forces provided by the respective rotors 132, 142.

FIG. 5 shows an example method 500 of controlling the rotor assemblies 130, 140 to provide thrust in a left-right direction.

At 502, the first rotor assembly 130 run its outer rotors 132(a) and 132(d) at a different speed than its inner rotors 132(b) and 132(c). As a result, a speed differential between the outer and inner rotors creates a torque which induces the first rotor assembly 130 to pivot about the local roll axis 202(c) (FIG. 2) relative to the first wing portion 114 (a). In this manner, the first rotor assembly 130 directs the forces 410 in a corresponding direction.

Similarly, at 504, the second rotor assembly 140 run its outer rotors 142(a) and 142(d) at a different speed than its inner rotors 142(b) and 142(c). As a result, the speed differential between the outer and inner rotors creates a torque which induces the second rotor assembly 140 to pivot about its local roll axis relative to the second wing portion 114 (b). In this manner, the second rotor assembly 140 directs the forces 420 in a corresponding direction.

FIG. 6 shows an example side view of the VTOL aircraft 100. As shown, the rotor assemblies 130, 140 provides the respective forces 410, 420 in the forward-aft direction. Further shown are headwind forces 630 which act against the VTOL aircraft 100.

During operation, the first rotor assembly 130 spins its forward rotors 132(a) and 132(b) faster than it spins its aft rotors 132(c) and 132(d). Similarly, the second rotor assembly 140 spins its inner rotors 132(a) and 132(b) faster than it spins its outer rotors 132(c) and 132(d). In this manner, the first rotor assembly 130 and the second rotor assembly 140 provide complementary forward thrust to counteract the headwind forces 630.

Although headwind forces 630 are shown, it should be understood that similar operation may be performed to counteract tailwind forces. That is, the first rotor assembly 130 may spin its forward rotors 132(a) and 132(b) slower than it spins its aft rotors 132(c) and 132(d), and the second rotor assembly 140 may spin its inner rotors 132(a) and 132(b) slower than it spins its outer rotors 132(c) and 132(d). As a result, the rotor assemblies 130, 140 provide the forces 410, 420 in the aftward direction.

FIG. 7 shows an example method 700 of controlling the rotor assemblies 130, 140 to provide thrust in a left-right direction relative to the VTOL aircraft 100.

At 702, the first rotor assembly 130 runs its forward rotors 132(a) and 132(b) at a different speed than its aft rotors 132(c) and 132(d). As a result, a speed differential between the forward and aft rotors creates a torque which induces the first rotor assembly 130 to pivot about the local pitch axis 202(b) (FIG. 2) relative to the first wing portion 114 (a).

Similarly, at 704, the second rotor assembly 140 runs its forward rotors 142(a) and 142(b) at a different speed than its aft rotors 142(c) and 142(d). As a result, a speed differential between the forward and aft rotors creates a torque which induces the second rotor assembly 140 to pivot about its local pitch axis relative to the second wing portion 114 (b).

FIG. 8 shows an example top-down view of the VTOL aircraft 100. As shown, the rotor assemblies 130, 140 provides the respective forces 410, 420 in the forward-aft direction relative to the VTOL aircraft 100. In particular, the forces 410 are provided in a forward direction, and the forces 420 are provided in an aftward direction. These forces 410, 420 may be provided, for example, using the method 700 described above in relation to FIG. 7. These forces create a torque inducing rotation of the VTOL aircraft 100 about the aircraft yaw axis 102(a).

FIG. 9 shows an example method 900 for rotating the VTOL aircraft 100 about the aircraft yaw axis 102(a).

At 902, the first rotor assembly 130 runs its forward rotors 132(a) and 132(b) slower than its aft rotors 132(c) and 132(d). As a result, a speed differential between the forward and aft rotors creates a torque which induces the first rotor assembly 130 to pivot about the local pitch axis 202(b) (FIG. 2) relative to the first wing portion 114 (a). In this manner, the first rotor assembly 130 directs forces 410 in a forward direction relative to the VTOL aircraft 100.

At 904, the second rotor assembly 140 runs its forward rotors 142(a) and 142(b) faster than its aft rotors 142(c) and 142(d). As a result, a speed differential between the forward and aft rotors creates a torque which induces the second rotor assembly 140 to pivot about its local pitch axis relative to the second wing portion 114 (b). In this manner, the second rotor assembly 140 directs forces 420 in a forward direction relative to the VTOL aircraft 100.

As the forces 410, 420 face opposite directions, a torque is created about the aircraft yaw axis 102(a). This torque induces the VTOL aircraft 100 to rotate about the yaw axis 102(a). It should be understood that similar operation may be performed to rotate the VTOL aircraft 100 in the opposite direction about the yaw axis 102(a). For example, the first rotor assembly 130 may run its forward rotors 132(a) and 132(b) faster than its aft rotors 132(c) and 132(d), and the second rotor assembly 140 runs its forward rotors 142(a) and 142(b) slower than its aft rotors 142(c) and 142(d). In that case, the resulting torque induces the VTOL aircraft 100 to rotate in the opposite direction.

FIG. 10 shows an example operation for vertical take-off of the VTOL aircraft 100 based on lift provided by the rotor assemblies 130, 140.

At 1002, the rotor assemblies 130, 140 transition from the stowed condition to the deployed condition. In the deployed condition, the first plurality of rotors 132 and the second plurality of rotors 142 extend from the respective pylons 134, 144.

At 1004, the first plurality of rotors 132 and the second plurality of rotors 142 operate to provide lift to the VTOL aircraft 100. Based on the lift, the VTOL aircraft 100 vertically rises above ground.

At 1006, once above ground, the propeller 112 (FIG. 1) operates to provide horizontal thrust to the VTOL aircraft 100. Based on the horizontal thrust, the wing portions 114 (a), 114 (b) provides lift to the VTOL aircraft 100.

At 1008, the rotor assemblies 130, 140 transition from the deployed condition to the stowed condition. In the stowed condition, the first plurality of rotors 132 and the second plurality of rotors 142 are stowed within the respective pylons 134, 144.

At 1010, a set of pivot-locking actuators engages to prevent the rotor assemblies 130, 140 from pivoting about their respective joints relative to the VTOL aircraft 100. In this manner, the pylons 134, 144 may be positioned for maximum aerodynamic efficiency.

FIG. 11 shows an example operation for vertically landing the VTOL aircraft 100 under control of the rotor assemblies 130, 140.

At 1102, the set of pivot-locking actuators disengages to allow the rotor assemblies 130, 140 to pivot about their respective joints relative to the VTOL aircraft 100.

At 1104, the rotor assemblies 130, 140 transition from the stowed condition to the deployed condition. In the deployed condition, the first plurality of rotors 132 and the second plurality of rotors 142 extend from the respective pylons 134, 144.

At 1106, the first plurality of rotors 132 and the second plurality of rotors 142 operate to hover, position, and/or land the VTOL aircraft. For example, the first plurality of rotors 132 and the second plurality of rotors 142 may position the VTOL aircraft 100 above a predetermined landing location. Once above the predetermined landing location, the VTOL aircraft 100 may vertically land under control of the first plurality of rotors 132 and the second plurality of rotors 142.

In some embodiments, operating the first rotor assembly 130 and the second rotor assembly 140 provides relatively high horizontal thrust (e.g., a 0.2 g-force lateral load created from a 11.3-degree tilt) without needing to tilt the entire VTOL aircraft 100. High horizontal thrust is particularly beneficial for aircraft yaw control (e.g., as described in connection with FIG. 8 and FIG. 9). In some embodiments, such aircraft yaw control provides a yaw moment according to the following formula, where M is the yaw moment, F is the total vertical lift force provided by all rotors (which is equal to vehicle weight when hovering), t is the tangent of the tilt angle of the rotors, and d is the distance between the attachment pivot points of the two rotor assemblies:

$$M = F \times t \times \frac{d}{2}$$

In some embodiments, the operations shown in FIGS. 5, 7, and 9-11 are performed by control circuitry that includes software constructs which reside in memory and run on a set of processors. The various acts of the example operations may be ordered in any suitable way. The control circuitry may be disposed within the VTOL aircraft 100 itself, or it may be disposed elsewhere, such as in a ground-based control station.

For example, in some embodiments, the rotor assemblies 130, 140 include one or more respective interfacing portions (not shown) coupled to respective rotors and/or rotor arms. The interfacing portions are constructed and arranged to contact one or more support points (not shown) on the respective wing portion while in the stowed condition. These interfacing portions prevent rotation about the respective joint while in the stowed condition and allow rotation while in the deployed condition. Advantageously, these interfacing portions enable the rotor assemblies 130, 140 to automatically fix the orientation of the rotor assemblies 130, 140 relative to the wing portions 114 (a), 114 (b) when stowing the rotors. Further, the interfacing portions enable the rotor assemblies 130, 140 to automatically unlock the joints when deploying the rotors.

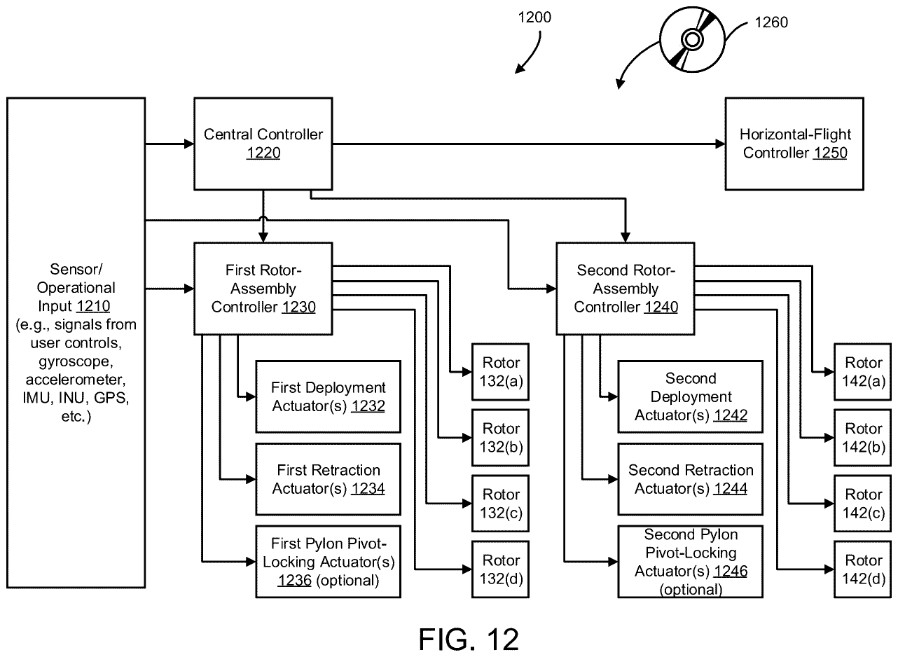

FIG. 12 shows an example control system 1200 constructed and arranged to control operation the VTOL aircraft 100 (including the first rotor assembly 130 and the second rotor assembly 140), e.g., based at least in part on sensor and/or operational input 1210. In some embodiments, the input 1210 is a set of signals generated based on local and/or remote user control, autonomously, combinations thereof, etc. For example, in some embodiments, the VTOL aircraft 100 may receive user commands (e.g., from a joystick, a pedal, a switch, a lever, etc.) and sensor signals, e.g., from a position sensor, a shaft position encoder, an inclinometer, an optical measurement system, an force transducer, a gyroscope, an accelerometer, an inertial measurement unit (IMU), a inertial navigation system (INS), a global positioning system (GPS), air speed sensor, a temperature sensor, a pressure sensor, a humidity sensor, a power management sensor, etc.), combinations thereof, etc.

A central controller 1220 is constructed and arranged to receive and process the sensor and/or operational input 1210 to generate instructions that direct operation of the VTOL aircraft 100, the first rotor assembly 132, and/or the second rotor assembly 134. The central controller 1220 is communicatively coupled with a first rotor assembly controller 1230, a second rotor-assembly controller 1240, and a horizontal-flight controller 1250.

The first rotor-assembly controller 1230 is constructed and arranged to receive the instructions from the central controller 1220 and direct operation of the first rotor assembly 130. As shown, the first rotor-assembly controller 1230 is communicatively coupled with the first rotors 132 to direct rotational speed, position, combinations thereof, etc. of the first rotors 132. Additionally, the first rotor-assembly controller 1230 is communicatively coupled with first deployment actuator(s) 1232, first retraction actuator(s) 1234, and optionally first pylon pivot-locking actuator(s) 1236 to direct operation of additional features of the first rotor assembly 130, as described below.

The first deployment actuator(s) 1232 is constructed and arranged to deploy the first rotors 132 from the first pylon 134. In some embodiments, the first deployment controls 1232 are constructed and arranged to release the rotor arms 220 and/or the pylon doors 222 to allow the first rotors 132 to swing outwardly from the first pylon 134.

The first retraction actuator(s) 1234 is constructed and arranged to stow the first rotors 132 at least partially within the first pylon 134. In some embodiments, the first retraction actuator(s) 1234 direct movement of the rotor arms and/or the pylon doors 222 to rotate the first rotors 132 inward into the first pylon 134.

The optional first pylon pivot-locking actuator(s) 1236 is constructed and arranged to fix orientation of the first rotor assembly 130 relative to the first wing portion 114 (a). In some embodiments, the first retraction actuator(s) 1234 is constructed and arranged to fix the orientation of the first rotor assembly 130, rather than the first pylon pivot-locking actuator(s) 1236. For example, in some embodiments, the first retraction actuator(s) 1234 is constructed and arranged to position one or more interfacing portions of the first rotors 132 and/or the rotor arms 220 to contact one or more support points on the first wing portion 114 (a) to prevent rotation of the first rotor assembly 130 relative to the first wing portion 114 (a) about the joint 210.

Similarly, the second rotor-assembly controller 1240 is constructed and arranged to receive the instructions from the central controller 1220 and direct operation of the second rotor assembly 140. As shown, the second rotor-assembly controller 1240 is communicatively coupled with the second rotors 142 to direct rotational speed, position, etc. of the second rotors 142. Additionally, the second rotor-assembly controller 1240 is communicatively coupled with second deployment actuator(s) 1242, second retraction actuator(s) 1244, and optionally second pylon pivot-locking actuator(s) 1246 to direct operation of additional features of the second rotor assembly 140, as described below.

The second deployment actuator(s) 1242 is constructed and arranged to deploy the second rotors 142 from the second pylon 144. In some embodiments, the second deployment actuator(s) 1242 is constructed and arranged to release rotor arms and/or pylon doors to allow the second rotors 142 to swing outwardly from the second pylon 144.

The second retraction actuator(s) 1244 is constructed and arranged to stow the second rotors 142 at least partially within the second pylon 144. In some embodiments, the second retraction actuator(s) 1244 direct movement of rotor arms and/or pylon doors to rotate the second rotors 142 inward into the second pylon 144.

The optional second pylon pivot-locking actuator(s) 1246 is constructed and arranged to fix orientation of the second rotor assembly 140 relative to the second wing portion 114 (b). In some embodiments, the second retraction actuator(s) 1244 is constructed and arranged to fix the orientation of the second rotor assembly 140, rather than the second pylon pivot-locking actuator(s) 1246. For example, in some embodiments, the second retraction actuator(s) 1244 is constructed and arranged to position one or more interfacing portions of the second rotors 142 and/or respective rotor arms to contact one or more support points on the second wing portion 114 (b) to prevent rotation of the second rotor assembly 140 relative to the second wing portion 114 (b) about a joint.

It should be understood that the control system 1200 is provided for example purposes, and in some embodiments, one or more of the central controller 1220, the first rotor-assembly controller 1230, the second rotor-assembly controller 1240, and the horizontal-flight controller 1250 are part of a single controller. Further, in some embodiments, multiple and/or different controllers are constructed and arranged to direct the operation of certain features than those explicitly shown in FIG. 12. For example, in some embodiments, both the central controller 1220 and the first rotor-assembly controller 1320 are constructed and arranged to direct the operation of the first deployment actuator(s) 1232, etc.

The horizontal-flight controls 1250 of the VTOL aircraft 100 are constructed and arranged to control the propeller 112 and other features (e.g., ailerons, elevators, rudders, etc.) for horizontal flight.

In some embodiments, respective centers of gravity of the first rotor assembly 130 and the second rotor assembly 140 are aligned with the center of gravity 104 in a transverse plane (e.g., a plane defined by the aircraft yaw axis 102(a) and the aircraft pitch axis 102(b)). Advantageously, by aligning the respective centers of gravity of the rotor assemblies and the VTOL aircraft, less or no differential speed between rotors is required to maintain vertical thrust.

Having described certain embodiments, numerous alternative embodiments or variations can be made. For example, changes in form and details for attaching the rotor assemblies to a VTOL aircraft, extending and/or retracting rotor of the rotor assemblies, pivoting the rotor assemblies relative to a VTOL aircraft, combinations thereof, etc. are possible without departing from the spirit and scope of the present disclosure. Along these lines, although the VTOL aircraft 100 was described above, certain embodiments are directed to different types of VTOL aircraft, e.g., helicopters, wingless drones, etc. Further, in some embodiments, the rotor assemblies may be attached to non-wing portions of a VTOL aircraft, such as arm members extending from a central aircraft body. In addition, the improved technique may be implemented in multiple ways, e.g., as a purpose-built VTOL aircraft having the rotor assemblies, as an addon kit for upgrading an existing VTOL aircraft, etc.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 1260 in FIG. 12). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first” event, or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

TABLE of References

| Reference Number | Description |
|---|---|
| 100 | A vertical take-off and landing (VTOL) aircraft 100. |
| 102(a), 102(b), | An aircraft yaw (normal) axis, an aircraft pitch (transverse) axis, |
| 102(c) | and an aircraft roll (longitudinal) axis of the VTOL aircraft 100. |
| 104 | A center of gravity 104 of the VTOL aircraft 100. |
| 110 | A fuselage 110 of the VTOL aircraft 100. |
| 112 | A propeller 112 of VTOL aircraft 100 constructed and arranged |
| | to provide thrust for horizontal flight. |
| 114(a), 114(b) | A first wing portion 114(a) and a second wing portion 114(b) |
| (collectively, 114) | (collectively, wing portions 114) of VTOL aircraft 100, the first |
| | wing portion 114(a) and the second wing portion 114(b) being |
| | coupled with the fuselage 110. |
| 130 | A first rotor assembly 130 mounted to a first underside of the first |
| | wing portion 114(a), the first rotor assembly being pivotable |
| | relative to the first wing portion 114(a). |
| 132(a), 132(b), | Multiple first rotors 132(a) through (d) (collectively, first rotors |
| 132(c), 132(d) | 132) of the first rotor assembly 130. The first rotors 132 are |
| (collectively, 132) | constructed and arranged to provide vertical and positional thrust |
| | to the VTOL aircraft 100. |
| 134 | A first pylon 134 of the first rotor assembly 130. |
| 140 | A second rotor assembly 140 mounted to a second underside of |
| | the second wing portion 114(b), the second rotor assembly 140 |
| | being pivotable relative to the second wing portion 114(b). |
| 142(a), 142(b), | Multiple second rotors 142(a) through (d) (collectively, second |
| 142(c), 142(d) | rotors 142) of the second rotor assembly 140. The second rotors |
| (collectively 142) | 142 are constructed and arranged to provide positional thrust to |
| | the VTOL aircraft 100. |
| 144 | A second pylon 144 of the second rotor assembly 140. |
| 202(a), 202(b), | A yaw (normal) axis 202(a), a pitch (transverse) axis 202(b), and |
| 202(c) | a roll (longitudinal) axis 202(c) of the first rotor assembly 130. |
| | In some embodiments, the yaw axis 202(a), the pitch axis 202(b), |
| | and the roll axis 202(c) are parallel to the aircraft yaw axis |
| | 102(a), the aircraft pitch axis 102(b), and the aircraft roll axis |
| | 102(c), respectively. |
| 210 | A joint 210 that couples the first rotor assembly 130 and the |
| | underside of the first wing portion 114(a). |
| 212 | A central member 212 of the first rotor assembly 130. |
| 214 | A forward end 214 of the central member 212. |
| 216 | An aft end 216 of the central member 212. |
| 220(a), 220(b), | Multiple rotor arms 220(a) through (d) (collectively, rotor arms |
| 220(c), 220(d) | 220) coupled with the first rotors 132 and hingedly attached to |
| (collectively, 220) | the central member 212. |
| 222(a), 222(b), | Multiple pylon doors 222(a) through (d) (collectively, pylon |
| 222(c), 222(d) | doors 222) constructed and arranged to provide an |
| (collectively, 222) | aerodynamically streamlined profile when the first rotors 132 are |
| | stowed. |
| 224 | Landing features 224, such as legs, wheels, pads, etc. |
| 310 | A slot 310 defined by the first pylon 134 through which the first |
| | rotors 132 are configured to extend. |
| 410 | A set of thrust vectors 410 indicating a direction of thrust from |
| | operation of the first rotors 132. |
| 420 | A set of thrust vectors 420 indicating a direction of thrust from |
| | operation of the second rotors 142. |
| 430 | A horizontal crosswind 430 against the VTOL aircraft 100. |
| 500 | A method 500 of an example operation in which the VTOL |
| | aircraft 100 rotates about the aircraft roll axis 102(c) without the |
| | use of actuators. |
| 502, 504 | Steps 502 and 504 of the flowchart 500. |
| 630 | A headwind 630 against the VTOL aircraft 100. |
| 700 | A method 700 of an example operation in which the VTOL |
| | aircraft 100 rotates about the aircraft pitch axis 102(b) without the |
| | use of actuators. |
| 702, 704 | Steps 702 and 704 of the flowchart 700. |
| 810 | Arrow 810 indicating a direction of movement of the VTOL |
| | aircraft 100 when rotating about the aircraft yaw axis 102(a). |
| 900 | A method 900 of an example operation in which the VTOL |
| | aircraft 100 rotates about the aircraft yaw axis 102(a) without the |
| | use of actuators. |
| 902, 904 | Steps 902 and 904 of the method 900. |
| 1000 | A method 1000 of an example operation in which the VTOL |
| | aircraft 100 performs vertical take-off. |
| 1002, 1004, 1006, | Steps 1002, 1004, 1006, 1008, and 1010 of the method 1000. |
| 1008, 1010 | |
| 1100 | A method 1100 of an example operation in which the VTOL |
| | aircraft 100 performs vertical landing, positionally adjusts, and/or |
| | hovers. |
| 1102, 1104, 1106 | Steps 1102, 1104, and 1106 of the method 1100. |
| 1200 | A control system 1200 constructed and arranged to control |
| | operation of the VTOL aircraft 100, the first rotor assembly 130, |
| | and the second rotor assembly 140. |
| 1210 | Sensor and/or operational input 1210. |
| 1220 | A central controller 1220 of the VTOL aircraft 100. |
| 1230 | A first rotor-assembly controller 1230 constructed and arranged |
| | to receive the instructions from the central controller 1220 and |
| | direct operation of the first rotor assembly 130. |
| 1232 | First deployment actuator(s) 1232 constructed and arranged to |
| | deploy the first rotors 132 from the first pylon 134. |
| 1234 | First retraction actuator(s) 1234 constructed and arranged to stow |
| | the first rotors 132 at least partially within the first pylon 134. |
| 1236 | First pylon pivot-locking actuator(s) 1236 constructed and |
| | arranged to fix orientation of the first pylon 134 relative to the |
| | first wing portion 114(a). |
| 1240 | A second rotor-assembly controller 1240 constructed and |
| | arranged to receive the instructions from the central controller |
| | 1220 and direct operation of the second rotor assembly 140. |
| 1242 | Second deployment actuator(s) 1242 constructed and arranged to |
| | deploy the second rotors 142 from the second pylon 144. |
| 1244 | Second retraction actuator(s) 1244 constructed and arranged to |
| | stow the second rotors 142 at least partially within the second |
| | pylon 144. |
| 1246 | Second pylon pivot-locking actuator(s) 1246 constructed and |
| | arranged to fix orientation of the second pylon 144 relative to the |
| | second wing portion 114(b). |
| 1250 | Horizontal-flight controls 1250 of the VTOL aircraft 100, the |
| | horizontal-flight controls 1250 being constructed and arranged to |
| | control the propeller 112 and other features (e.g., ailerons, |
| | elevators, rudders, etc.) for horizontal flight. |
| 1260 | Computer-readable medium 1260. |

What is claimed is:

1. A method of controlling a vertical take-off and landing (VTOL) aircraft, the method comprising:
operating a first plurality of rotors of a first rotor assembly pivotably attached to a first lateral portion of the VTOL aircraft by a first joint, the first plurality of rotors being constructed and arranged to tilt in unison as the first rotor assembly pivots about the first joint relative to the first lateral portion, the first lateral portion being disposed on a first side of a central axis of the VTOL aircraft;
operating a second plurality of rotors of a second rotor assembly pivotably attached to a second lateral portion of the VTOL aircraft by a second joint, the second plurality of rotors being constructed and arranged to tilt in unison as the second rotor assembly pivots about the second joint relative to the second lateral portion, the second lateral portion being disposed on a second side of the central axis opposite the first side; and
adjusting rotational speed of the first plurality of rotors and the second plurality of rotors to control the VTOL aircraft.

2. The method of claim 1, further comprising:
establishing a first difference in rotational speed of individual rotors of the first plurality of rotors to pivot the first rotor assembly about the first joint relative to the first lateral portion; and
establishing a second difference in rotational speed of individual rotors of the second plurality of rotors to pivot the second rotor assembly about the second joint relative to the second lateral portion.

3. The method of claim 1,
wherein the VTOL aircraft has a pitch axis,
wherein the first plurality of rotors includes multiple first forward rotors and multiple first aft rotors,
wherein the second plurality of rotors includes multiple second forward rotors and multiple second aft rotors, and
wherein the method further comprises:
operating the first forward rotors at different rotational speeds than the first aft rotors to pivot the first rotor assembly about a first axis parallel to the pitch axis; and
operating the second forward rotors at different rotational speeds than the second aft rotors to pivot the second rotor assembly about a second axis parallel to the pitch axis.

4. The method of claim 3,
wherein the VTOL aircraft has a yaw axis,
wherein operating the first forward rotors at different rotational speeds than the first aft rotors includes running the first aft rotors faster than the first forward rotors, and
wherein operating the second forward rotors at different rotational speeds than the second aft rotors includes running the second aft rotors slower than the second forward rotors,
thereby rotating the VTOL aircraft about the yaw axis.

5. The method of claim 1,
wherein the VTOL aircraft has a roll axis coinciding with the central axis,
wherein the first plurality of rotors includes multiple first inner rotors and multiple first outer rotors,
wherein the second plurality of rotors includes multiple second inner rotors and multiple second outer rotors, and
wherein the method further comprises:
operating the first inner rotors at different rotational speeds than the first outer rotors to pivot the first rotor assembly about a first axis parallel to the roll axis; and
operating the second inner rotors at different rotational speeds than the second outer rotors to pivot the second rotor assembly about a second axis parallel with the roll axis.

6. The method of claim 1,
wherein the first rotor assembly further includes a first central member coupled between the first joint and the first plurality of rotors,
wherein the second rotor assembly further includes a second central member coupled between the second joint and the second plurality of rotors, and
wherein the method further comprises:
directing the first rotor assembly and the second rotor assembly to assume a deployed condition in which the first plurality of rotors and the second plurality of rotors are extended outwardly from the first central member and the second central member, respectively; and
directing the first rotor assembly and the second rotor assembly to assume a stowed condition in which the first plurality of rotors and the second plurality of rotors are retracted inwardly toward the first central member and the second central member, respectively.

7. The method of claim 6, further comprising transitioning each of the first rotor assembly and the second rotor assembly from the deployed condition to the stowed condition as the VTOL aircraft moves forward above ground.

8. The method of claim 6, further comprising:
while the VTOL aircraft is above ground, transitioning each of the first rotor assembly and the second rotor assembly from the stowed condition to the deployed condition;
running the first plurality of rotors and the second plurality of rotors to position the VTOL aircraft above a predetermined landing location; and
vertically landing the VTOL aircraft at the predetermined landing location under control of the first plurality of rotors and the second plurality of rotors.

9. A vertical take-off and landing (VTOL) aircraft, comprising:
a first lateral portion and a second lateral portion, the first lateral portion being disposed on a first side of a central axis of the VTOL aircraft, the second lateral portion being disposed on a second side of the central axis opposite the first side;
a first rotor assembly pivotably attached to the first lateral portion by a first joint, the first rotor assembly including a first plurality of rotors constructed and arranged to tilt in unison as the first rotor assembly pivots about the first joint relative to the first lateral portion; and
a second rotor assembly pivotably attached to the second lateral portion by a second joint, the second rotor assembly including a second plurality of rotors constructed and arranged to tilt in unison as the second rotor assembly pivots about the second joint relative to the second lateral portion.

10. The VTOL aircraft of claim 9,
wherein the first rotor assembly is constructed and arranged to pivot about the first joint relative to the first lateral portion based on a first difference in rotational speed of individual rotors of the first plurality of rotors, and
wherein the second rotor assembly is constructed and arranged to pivot about the second joint relative to the second lateral portion based on a second difference in rotational speed of individual rotors of the second plurality of rotors.

11. The VTOL aircraft of claim 10, wherein each of the first plurality of rotors and the second plurality of rotors includes at least four respective rotors.

12. The VTOL aircraft of claim 11, wherein each of the first plurality of rotors and the second plurality of rotors includes at least two forward rotors and at least two aft rotors.

13. The VTOL aircraft of claim 11,
further comprising a roll axis coincident with the central axis;
wherein the first plurality of rotors includes at least two first inner rotors and at least two first outer rotors, the first inner rotors being disposed closer to the roll axis than the first outer rotors, and
wherein the second plurality of rotors includes at least two second inner rotors and at least two second outer rotors, the second inner rotors being disposed closer to the roll axis than the second outer rotors.

14. The VTOL aircraft of claim 9,
wherein the first rotor assembly further includes a first central member coupled between the first joint and the first plurality of rotors, and
wherein the second rotor assembly further includes a second central member coupled between the second joint and the second plurality of rotors.

15. The VTOL aircraft of claim 14,
wherein the first rotor assembly and the second rotor assembly are constructed and arranged to assume a deployed condition in which the first plurality of rotors and the second plurality of rotors are extended outwardly from the first central member and the second central member, respectively, and
wherein the first rotor assembly and the second rotor assembly are constructed and arranged to assume a stowed condition in which the first plurality of rotors and the second plurality of rotors are retracted inwardly toward the first central member and the second central member, respectively.

16. The VTOL aircraft of claim 15, further comprising a set of motors constructed and arranged to transition the first plurality of rotors and the second plurality of rotors from the deployed condition to the stowed condition.

17. The VTOL aircraft of claim 16, wherein each of the first rotor assembly and the second rotor assembly is constructed and arranged to be biased toward the deployed condition by a respective set of tensioners.

18. The VTOL aircraft of claim 15, wherein each of the first rotor assembly and the second rotor assembly includes a respective enclosure constructed and arranged to at least partly contain a respective one of the first plurality of rotors and the second plurality of rotors while in the stowed condition.

19. The VTOL aircraft of claim 9,
further comprising a yaw axis,
wherein the first joint is constructed and arranged to restrict pivoting of the first rotor assembly about a first axis parallel to the yaw axis, and
wherein the second joint is constructed and arranged to restrict pivoting of the second rotor assembly about a second axis parallel to the yaw axis.

20. A vertical take-off and landing (VTOL) system for an aircraft, the VTOL system comprising:
a first rotor assembly constructed and arranged to pivotably attach to a first lateral portion of the aircraft by a first joint, the first rotor assembly including a first plurality of rotors constructed and arranged to tilt in unison as the first rotor assembly pivots about the first joint relative to the first lateral portion, the first lateral portion being disposed on a first side of a central axis of the VTOL aircraft;
a second rotor assembly constructed and arranged to pivotably attach to a second lateral portion of the aircraft by a second joint, the second rotor assembly including a second plurality of rotors constructed and arranged to tilt in unison as the second rotor assembly pivots about the second joint relative to the second lateral portion, the second lateral portion being disposed on a second side of the central axis opposite the first side; and
control circuitry constructed and arranged to control the first rotor assembly and the second rotor assembly for VTOL operation.
